(19) United States
(12) Patent Application Publication
(10) Pub. No.: US 2014/0210957 A1
(43) Pub. Date: Jul. 31, 2014

(54) STEREOSCOPIC IMAGING APPARATUS AND METHOD OF DISPLAYING IN-FOCUS STATE CONFIRMATION IMAGE

(71) Applicant: FUJIFILM Corporation, Tokyo (JP)

(72) Inventor: Yuko KODAMA, Saitama-shi (JP)

(73) Assignee: FUJIFILM Corporation, Tokyo (JP)

(21) Appl. No.: 14/229,720

(22) Filed: Mar. 28, 2014

Related U.S. Application Data
(63) Continuation of application No. PCT/JP2012/068599, filed on Jul. 23, 2012.

(30) Foreign Application Priority Data
Sep. 30, 2011 (JP) 2011-218531

(51) Int. Cl. H04N 13/02

(52) U.S. Cl. CPC H04N 13/0207
USPC 348/50

(57) ABSTRACT

In a stereoscopic imaging apparatus including: a stereoscopic imaging section which takes an image of an object to obtain a plurality of images 41, 42 of different viewpoints; and a display section which displays the plurality of images 41, 42 as a stereoscopic image of the object, an image 41a of a region is displayed overlappingly on a part of the stereoscopic image as an in-focus state confirmation image 43, the region including a focus adjustment target region in taking of one of the plurality of images 41, 42.

### CROSS REFERENCE TO RELATED APPLICATION

This is a continuation of International Application No. PCT/JP2012/068599 filed on Jul. 23, 2012, and claims priority from Japanese Patent Application No. 2011-218531 filed on Sep. 30, 2011, the entire disclosure of which is incorporated herein by reference.

### TECHNICAL FIELD

The present invention relates to a stereoscopic imaging apparatus such as a stereo camera, and more particularly to a stereoscopic imaging apparatus in which, while viewing an image in a focus area, the user can easily determine whether an in-focus state is attained or not, and a method of displaying an in-focus state confirmation image therein.

### BACKGROUND ART

A stereoscopic imaging apparatus (stereoscopic camera) is configured so that an object image viewed by the right eye, and that viewed by left eye are simultaneously taken, and a right-eye object image and a left-eye object image are alternately displayed for each frame on a display section which is disposed on the back surface of the stereoscopic camera, and to which a lenticular lens sheet is applied, whereby a pseudo stereoscopic object image is displayed.

When an object is to be imaged by using such a stereoscopic camera, while causing a through image output from an imaging device (image sensor) on the display section, and determining the composition of the object, the user determines whether a stereoscopic image in which the object is in focus can be taken or not. In a stereoscopic image, however, it is difficult to determine whether the object is in focus or not.

In the prior art disclosed in Patent Literature 1 below, therefore, a focus control is facilitated in the following manner. An object image to be displayed on a display section is displayed while being able to be switched to either a stereoscopic image or a planar image. When the user starts to a manual focus control, the display image is automatically switched to a planar image (two-dimensional image: one of a right-eye image and a left-eye image).

### CITATION LIST

### Patent Literature

Patent Literature 1: JP-A-2011-91482

### SUMMARY OF INVENTION

### Technical Problem

As in the prior art disclosed in Patent Literature 1 above, when a planar image is displayed on the display section, it is easy to determine whether an in-focus state is attained or not, as compared with the case where only a stereoscopic image is displayed. However, it is impossible to confirm the stereoscopic effect of the stereoscopic image or the appearance of the stereoscopic image, while confirming the focusing state through the planar image. Therefore, there is an inconvenience that switching from a two-dimensional display to a tree-dimensional display is necessary.

In the case where a moving object such as a pet animal, a child, or a wild bird is to be shot, when the appearance of a stereoscopic image and the degree of focusing cannot be confirmed within a short time period, particularly, the photo opportunity is missed. Therefore, the prior art in which the display on the display section must be switched over has a problem in that the possibility of missing the photo opportunity is high.

It is an object of the invention to provide a stereoscopic imaging apparatus in which confirmation of the focusing state, and that of the appearance of a stereoscopic image can be simultaneously performed, and a method of displaying an in-focus state confirmation image therein.

### Solution to Problem

The stereoscopic imaging apparatus of the invention is characterized in that the apparatus includes: a stereoscopic imaging section which takes an image of an object to obtain a plurality of images of different viewpoints; a display section which displays the plurality of images as a stereoscopic image of the object; and a display control section which overlappingly displays an image of a region on a part of the stereoscopic image as an in-focus state confirmation image, the region including a focus adjustment target region in taking of one of the plurality of images.

Moreover, the method of displaying an in-focus state confirmation image of the invention is a method of displaying an in-focus state confirmation image in a stereoscopic imaging apparatus including: a stereoscopic imaging section which takes an image of an object to obtain a plurality of images of different viewpoints; and a display section which displays the plurality of images as a stereoscopic image of the object, and characterized in that an image of a region is displayed overlappingly on a part of the stereoscopic image, as an in-focus state confirmation image, the region including a focus adjustment target region in taking of one of the plurality of images.

### Advantageous Effects of Invention

According to the invention, the stereoscopic effect of a stereoscopic image of an object, and an in-focus state confirmation image can be simultaneously confirmed, and therefore a high-quality stereoscopic object image can be taken without missing the photo opportunity.

### BRIEF DESCRIPTION OF DRAWINGS

FIG. 1 is an external perspective view of a stereoscopic imaging apparatus (stereoscopic camera) of an embodiment of the invention.

FIG. 2 is a functional block diagram of the stereoscopic camera shown in FIG. 1.

FIG. 3 is a rear view of the stereoscopic camera shown in FIG. 1.

FIG. 4 is a view illustrating a stereoscopic image.

FIG. 5 is a view showing a display example of an in-focus state confirmation image in the embodiment of the invention.

FIG. 6 is a flowchart showing the procedure of a process of displaying the in-focus state confirmation image in the embodiment of the invention.

FIG. 7 is a view illustrating resizing of the in-focus state confirmation image in the embodiment of the invention.

FIG. 8 is a view illustrating an example of synthesis of the in-focus state confirmation image in the embodiment of the invention.

FIG. 9 is a view illustrating the procedure of production of the in-focus state confirmation image in the embodiment of the invention, and a display image on a display section.

FIG. 10 is a view illustrating the depth position (pop-out amount/pop-in amount) of the in-focus state confirmation image.

FIG. 11 is a view illustrating a stereoscopic image and a parallax amount.

FIG. 12 is a view showing correspondence relationships between the parallax amount and the depth position (pop-out amount/pop-in amount) of the in-focus state confirmation image.

FIG. 13 is a view showing a control of the depth position (pop-out amount/pop-in amount) of the in-focus state confirmation image by using pixel shifting.

FIG. 14 is a view illustrating a manner in which a focus detection area is moved to overlap the in-focus state confirmation image.

FIG. 15 is a view illustrating switching of a display region of the in-focus state confirmation image.

FIG. 16 is a view illustrating a method of dealing with the case where an image of a main object and the in-focus state confirmation image overlap each other.

### DESCRIPTION OF EMBODIMENTS

Hereinafter, an embodiment of the invention will be described with reference to the drawings.

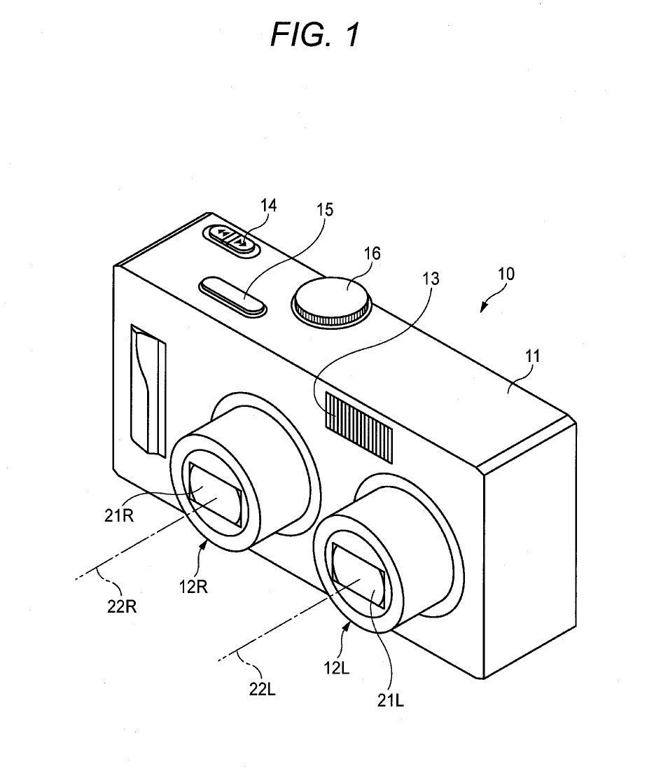

FIG. 1 is an external perspective view of a stereoscopic imaging apparatus (in the embodiment, a digital camera for shooting a stereoscopic image and having two right and left lenses, hereinafter simply referred to as a stereo camera, or simply as a camera). The stereo camera 10 includes: a box-like housing 11; an imaging section 12R for the right eye, and an imaging section 12L for the left eye which are juxtaposed in the front portion of the housing 11, and which function as a stereoscopic imaging section; a flashlight 13 which is disposed in the left shoulder portion of the front surface of the housing 11; and a power switch 14, shutter button 15, and mode selection dial 16 which are disposed at adequate places of the upper surface of the housing 11.

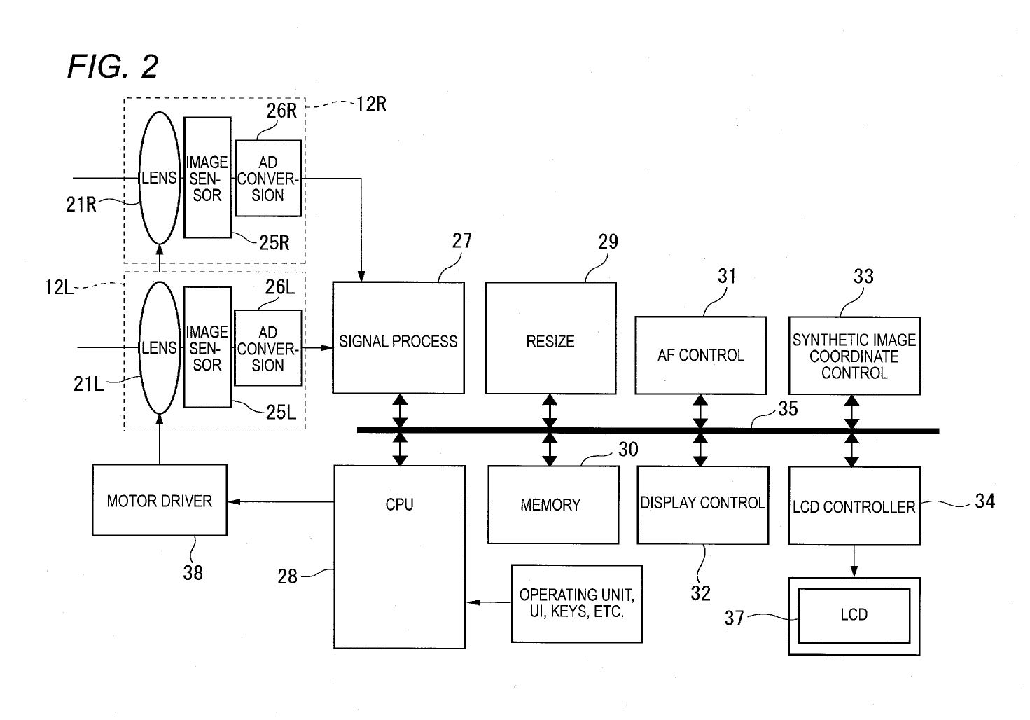

On the back surface side of the housing 11, a liquid crystal display section (monitor) 37 shown in FIG. 2 is provided. A through image, a mode selection screen, a menu screen, a guidance display, and the like are displayed.

The imaging section 12R includes an imaging lens 21R in the front portion, and the imaging section 12L includes an imaging lens 21L in the front portion. The angle at which the optical axis 22R of the imaging lens 21R, and the optical axis 22L of the imaging lens 21L cross each other is referred to as the convergence angle. An actuator which controls the directions of the imaging sections 12R, 12L so that the convergence angle coincides with a target angle may be incorporated in the stereo camera 10. Alternatively, the convergence angle between the imaging lenses 21R, 21L may be fixed, and the misalignment amount between left and right taken images is adjusted by an image processing technique, whereby the stereoscopic effect of the stereoscopic image can be controlled.

The imaging lenses 21R, 21L can be independently subjected to adjustments of the focal length and the zoom magnification. In a stereoscopic image shooting mode, however, the imaging lenses 21R, 21L are controlled in an interlocked manner by a motor driver 38 which will be described later, and one of the imaging lenses and the other imaging lens are controlled to the same in-focus position.

FIG. 2 is a functional block diagram of the stereoscopic camera 10 shown in FIG. 1. The stereoscopic camera 10 includes a right-eye image sensor 25R which is placed in a back surface portion of the imaging lens 21R, and an AD converter 26R which converts the output of the image sensor 25R to digital data, and also includes a left-eye image sensor 25L which is placed in a back surface portion of the imaging lens 21L, and an AD converter 26L which converts the output of the image sensor 25L to digital data.

The stereoscopic camera 10 further includes: a signal process section 27 which receives the outputs of the AD converters 26R, 26L; a system control section (CPU) 28 which generally controls the whole stereo camera 10; a resize section 29 which resizes the taken images; a work memory 30 such as a frame memory; an AF control section 31 which processes the taken image data to perform an AF control; a display control section 32; a synthetic image coordinate control section 33, and an LCD controller 34. These components are connected to one another through a bus 35, and operate in accordance with instructions of the CPU 28.

The liquid crystal display section (LCD) 37 disposed on the back surface of the camera 10 is connected to the LCD controller 34, and the motor driver 38 connected to the CPU 28 drives focus control motors of the imaging lenses 21R, 21L. An operating unit including the shutter button 15, and a user interface key and the like 39 are connected to the CPU 28.

The CPU 28 has a main-object region detecting function of analyzing object images which are image-processed by the subordinate signal process section 27, and detecting a region including at least a part of the main object therein. A focus area is set so that focusing is obtained on the main object which is detected by the function. Although not shown, an external memory which records the taken image data, such as a memory card is connected to the bus 35 through a memory interface.

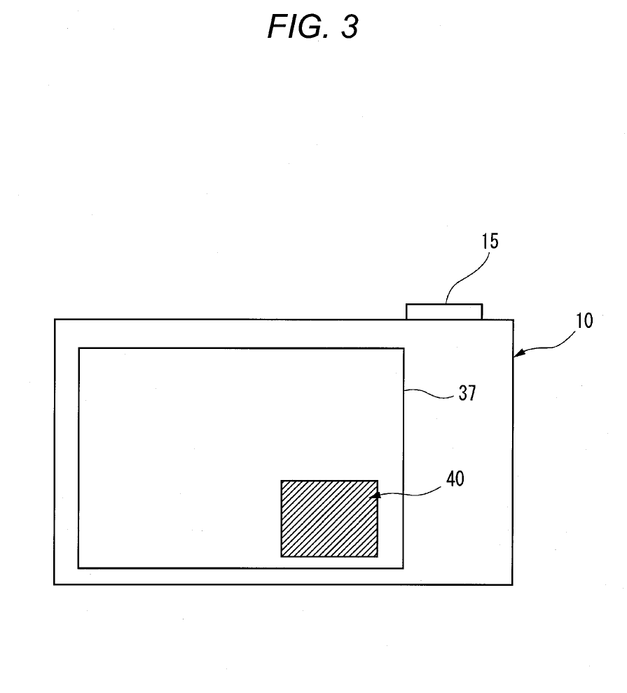

FIG. 3 is a rear view of the stereoscopic camera 10. The liquid crystal display section 37 is disposed on the back surface of the camera 10, and the taken images are displayed on the display section 37. For example, through images which are output from the image sensors 25R, 25L are displayed as a stereoscopic image.

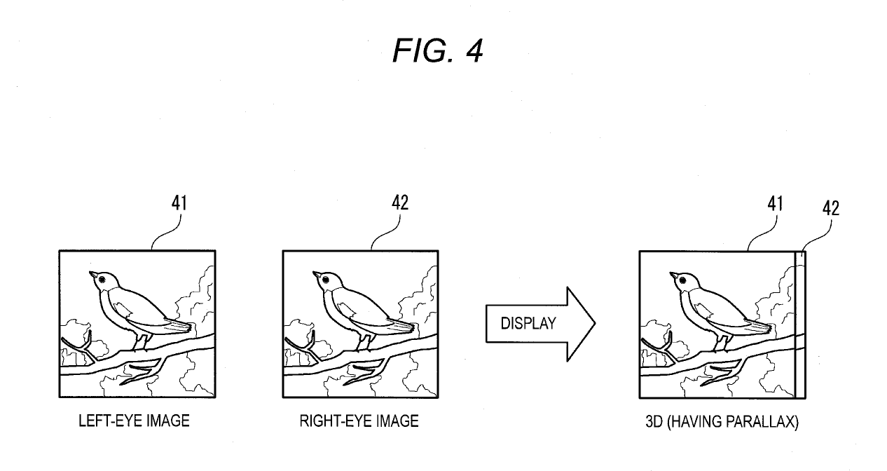

When a left-eye image (output image of the image sensor 25L) 41 in FIG. 4, and a right-eye image (output image of the image sensor 25R) 42 are alternately displayed for each frame on the display section 37, for example, only the left-eye image 41 emitted from the display section 37 to which a lenticular lens sheet (not shown) is applied enters the left eye of a person who views the display section 37, and only the right-eye image 42 enters the right eye. As shown in the right side of FIG. 4, therefore, a stereoscopic image (in the illustrated example, a stereoscopic image of a bird) is reproduced by the left-eye image 41 and the right-eye image 42 which is little displaced therefrom.

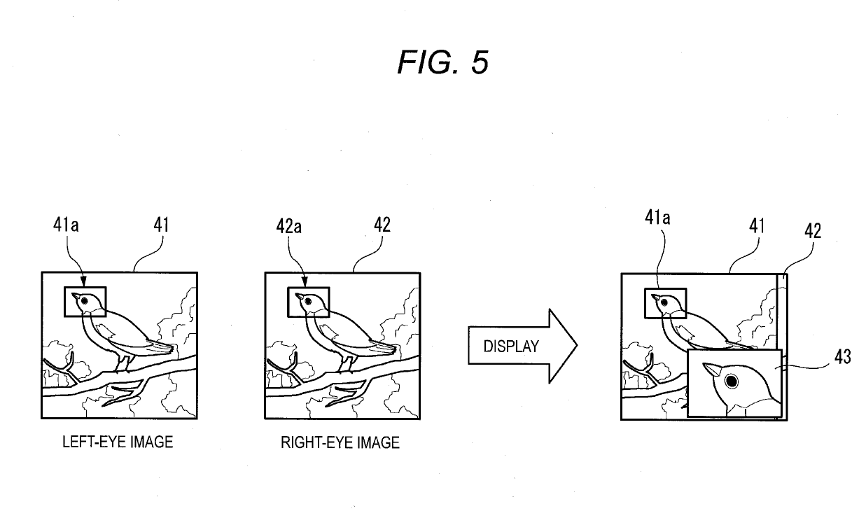

At this time, as shown in FIG. 5, an AF area 41a in the left-eye image 41, and an AF area 42a in the right-eye image 42 are areas where an image of a head portion of the bird is produced. In the embodiment, as shown in FIG. 3, a display region 40 that is used for confirming an in-focus state, and that is wider than the AF areas 41a, 42a is disposed in a region (in the illustrated example, a lower right region) which functions as a focus adjustment target region in imaging, and in which the possibility that an image of the main object is not produced is high in the display section 37, and only the left-eye image of the bird head portion the image of which is produced in the AF areas 41a, or the right-eye image of the bird head portion the image of which is produced in the AF areas 42a is displayed.

If the dominant eye of the user is the left eye and instructions for setting it is given, only the left-eye image of the bird head portion is displayed in the display region 40 for each frame. In a camera of the type in which one of the imaging lenses 21L, 21R, for example, the imaging lens 21L is preferentially subjected to the focusing control, and the focusing control of the other lens or the imaging lens 21R is subjected to a follow-up control based on the control value of the imaging lens 21L, alternatively, an AF magnified image of the image taken by the imaging lens 21L (in this example, the left-eye image) is displayed.

In the display region 40, therefore, the taken images of the AF areas 41a, 42a are displayed as two-dimensional images, and hence it is possible to determine whether an in-focus state is attained or not. In the whole screen, moreover, the stereoscopic image is displayed, and therefore the degree of the stereoscopic effect can be visually checked at the same time as the confirmation of focusing.

Since the sizes of the images of the actual AF areas 41a, 42a are different from the image size displayed in the display region 40, the resize section 29 in FIG. 2 produces an AF area image matching with the display region 40, and the image is displayed.

In the above description, the display region 40 is disposed in the display section 37, and the magnified image for in-focus state confirmation is displayed therein. Alternatively, a display image in the focus area in the stereoscopic image may be displayed as an in-focus state confirmation image. A display screen which is mounted on a recent digital camera is getting larger. Even when an in-focus state confirmation image is directly displayed in the focus area in a stereoscopic image, therefore, it is possible to confirm the in-focus state. Further alternatively, the display region 40 which is magnified around the focus area in the stereoscopic image may be disposed, and an in-focus state confirmation image may be displayed therein. The place where the display region 40 is disposed is not limited to a lower right region of the display section 37.

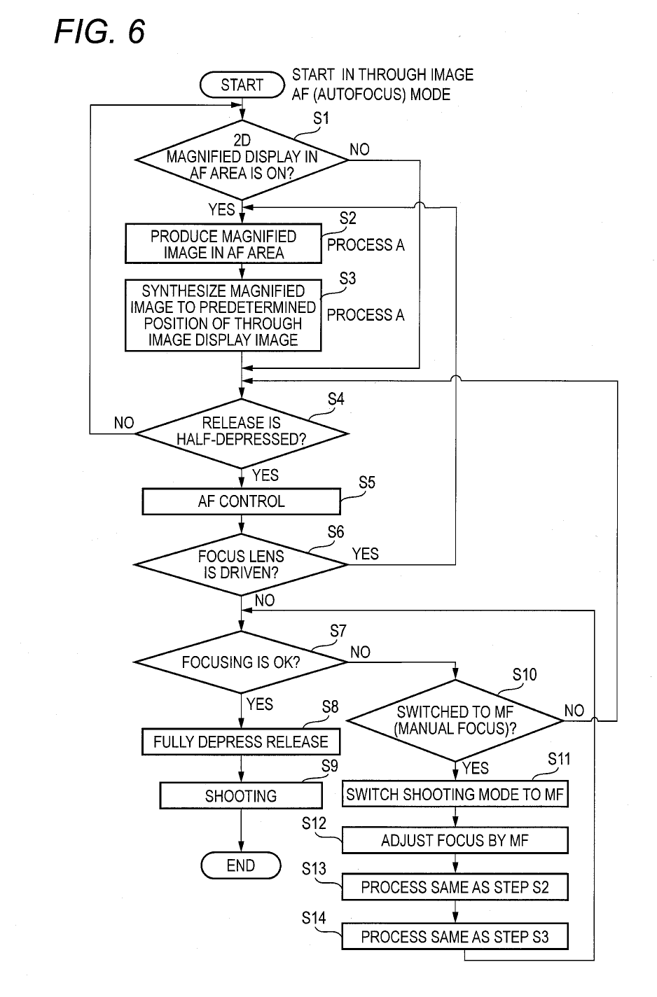

FIG. 6 is a flowchart showing the procedure of a process of executing the above-described embodiment, and the flowchart is executed by the CPU 28 in FIG. 2 by using the subordinate resize section 29 and the like. It is assumed that the stereoscopic camera 10 is driven in an autofocus mode.

First, it is determined in step S1 whether a magnified display of a planar image in the AF area is set ON by instructions from the user or not. If the result of the determination is affirmative or a magnified display of the image in the AF area is to be performed, the process proceeds to next step S2 to produce a magnified image (stereoscopic image) of the image in the AF area.

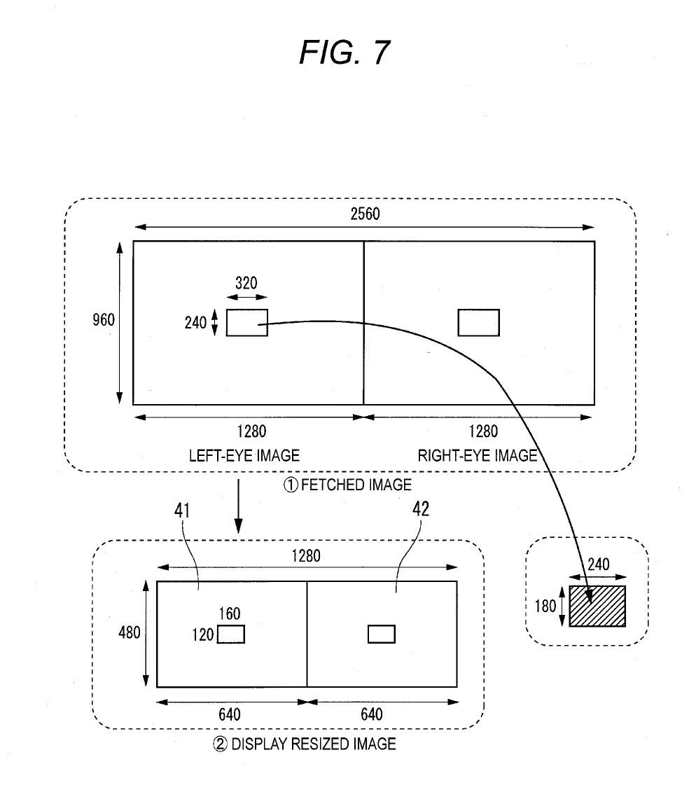

FIG. 7 is a view illustrating the production of a magnified image of the AF area image. For example, the signal process section 27 in FIG. 2 fetches through images of 1280×950 pixels from the image sensors 25R, 25L. In order to display the through images on the display section 37, the resize section 29 reduces the sizes of the through images to the respective images 41, 42 of 640×480 pixels, and causes the reduced images to be displayed on the display section 37.

In step S3 which is the step subsequent to step S2 in FIG. 6, a process of synthesizing (superimposing) the magnified image of the AF area image to the predetermined position (position of the display region 40) of the display image of the through image. The synthesizing (superimposing) process is performed in the following manner.

The AF area on the display image (reduced image) shown in FIG. 7 has a size of 160×120 pixels. The magnification is performed in order to display the image of the AF area in the display region 40. An image of 160×120 pixels is not magnified, but the AF area image of 320×240 pixels before reduction is resized to an image 43 of 240×180 pixels, and this image is displayed in the display region 40.

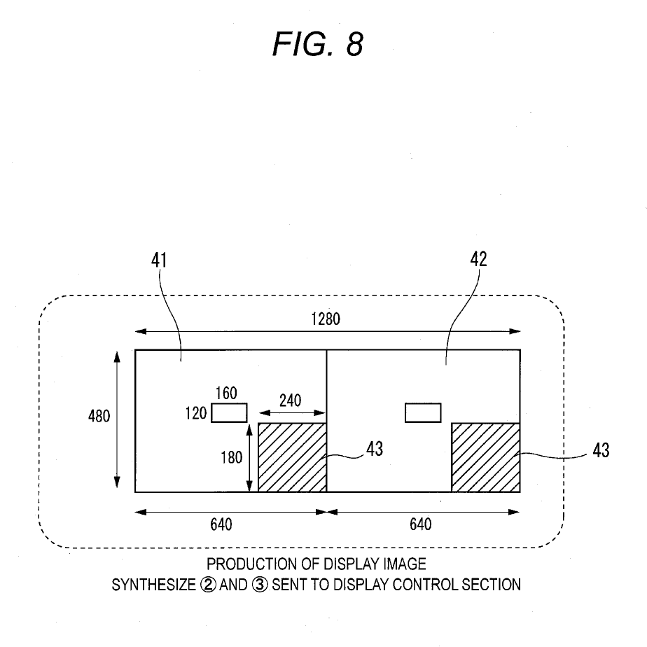

As shown in FIG. 8, the resized image 43 of 240×180 pixels is embedded in the position of the display regions 40 of the display images 41, 42, and the image 41 into which the image 43 is embedded, and the image 42 into which the image 43 is embedded are alternately displayed for each frame. Therefore, the in-focus state confirmation image 43 is two-dimensionally displayed in the stereoscopic image.

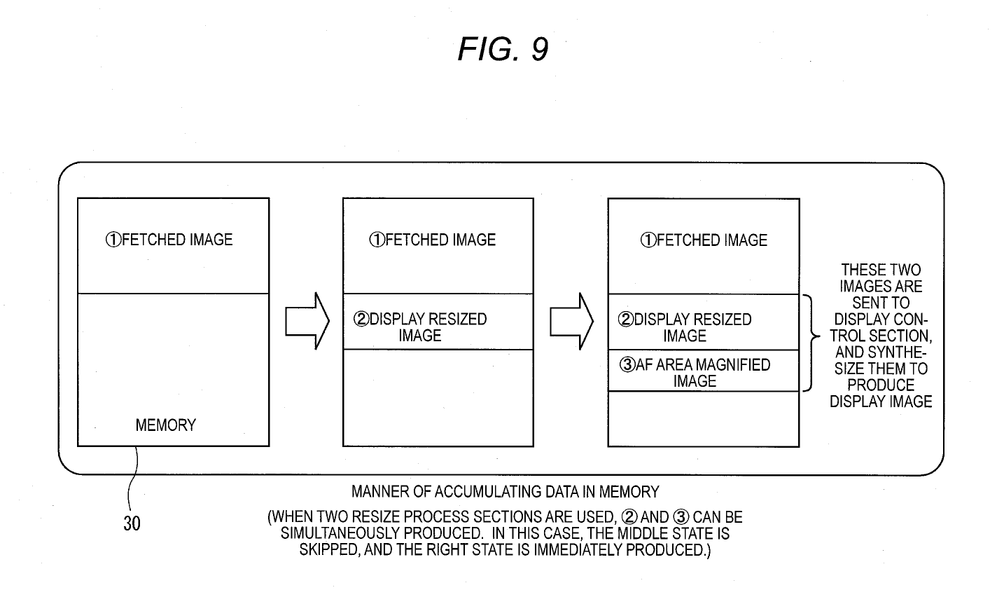

FIG. 9 is a view illustrating the process using the memory 30 shown in FIG. 2. The memory 30 temporarily stores the image data (fetched images) which are output from the image sensors 25R, 25L. The resize section 29 performs the reduction process on the image data to produce the display images 41, 42. The display images are temporarily stored in the memory 30. Next, the magnified image 43 of the AF area image is produced, and also the produced image is temporarily stored in the memory 30. The display resized images 41, 42 and the AF area magnified image 43 are synthesized with each other, and then sent to the display control section 32, whereby the synthetic image of FIG. 8 is displayed on the display section 37.

If the camera has two resize sections 29, the display resized images 41, 42 and the AF area magnified image 43 can be simultaneously produced, and therefore the speed of the process can be increased.

Returning to FIG. 6, after step S3, the process proceeds to step S4 to wait for half-depressing of the shutter button. If the half-depression state is not detected, the process returns to step S1, and, if the half-depression state is attained, the process proceeds to the next step or step S5. Also in the case where it is not determined as a result of the determination of step S1 that instructions for displaying the magnified image of the AF area image are not given, the process proceeds to step S5.

In step S5, a predetermined well-known AF control such as the contrast AF control, the phase difference AF control, the hill climbing method, or the like is performed. In next step S6, it is determined whether the motor driver 38 in FIG. 2 drives the focus lens in accordance with the AF value by instructions from the CPU 28 or not.

If it is determined in step S6 that the focus lens is driven, this means that the taken image is updated, and therefore the process returns to step S2 to again produce the magnified image of the AF area image, and again synthesize the magnified image of the AF area image with the through-image display image.

If it is determined in the result of the determination in step S6 that the focus lens is not driven, there is no change in the taken image, and therefore the process proceeds to step S7.

In step S7, the user visually checks the magnified image of the AF area image to determine whether focusing is obtained or not. If focusing is obtained, the process proceeds to step S8, the shutter release button is fully depressed, the process proceeds to an shooting process (step S9), and the process is ended.

If it is determined in the result of the determination in step S7 that focusing is not obtained, the camera then determines whether instructions for switching to MF (Manual Focus) is given by instructions input by the user or not (step S10). If instructions for switching to MF are not given, the process returns the step S4, and, if instructions for switching to MF are given, the process proceeds to step S11 to switch the shooting mode to the MF mode.

In next step S12, the user adjusts a focus ring to manually move the focus lens. As a result, the taken image is updated, the process therefore proceeds to step S13 to perform the same process as that of step S2, then the same process as that of step S3 is performed in step S14, and the process returns to step S7.

When the focus ring is adjusted, the three-dimensional image and AF confirmation image on the screen are updated. If the user who views the images determines in step S7 that focusing is obtained, therefore, the process proceeds to step S8, and, if the user determines that focusing is not obtained, the process again proceeds to step S10.

According to the above-described embodiment, the magnified image (in-focus state confirmation image) of the focus area image is displayed as a 2D image without parallax in a partial region of the display section on which the stereoscopic image (three-dimensional image) is displayed, and therefore the stereoscopic image and the in-focus state confirmation image can be simultaneously visually checked, so that confirmation of the stereoscopic effect, and that of focusing can be simultaneously performed.

In the above-described embodiment, the AF area magnified image is displayed as a two-dimensional image in the three-dimensional image, so that the user can visually check the degree of focusing. The AF area magnified image may be displayed as an image having no parallax in a three-dimensional image. Alternatively, the AF area magnified image may be displayed while popping out toward the front side from the screen, or while popping in toward the back side from the screen. Namely, the depth position of the image may be controlled. The display control can be realized by horizontally displacing the AF area magnified image 43 which is embedded in the display image 42, with respect to the AF area magnified image 43 which is embedded in the display image 41.

Hereinafter, the embodiment will be described.

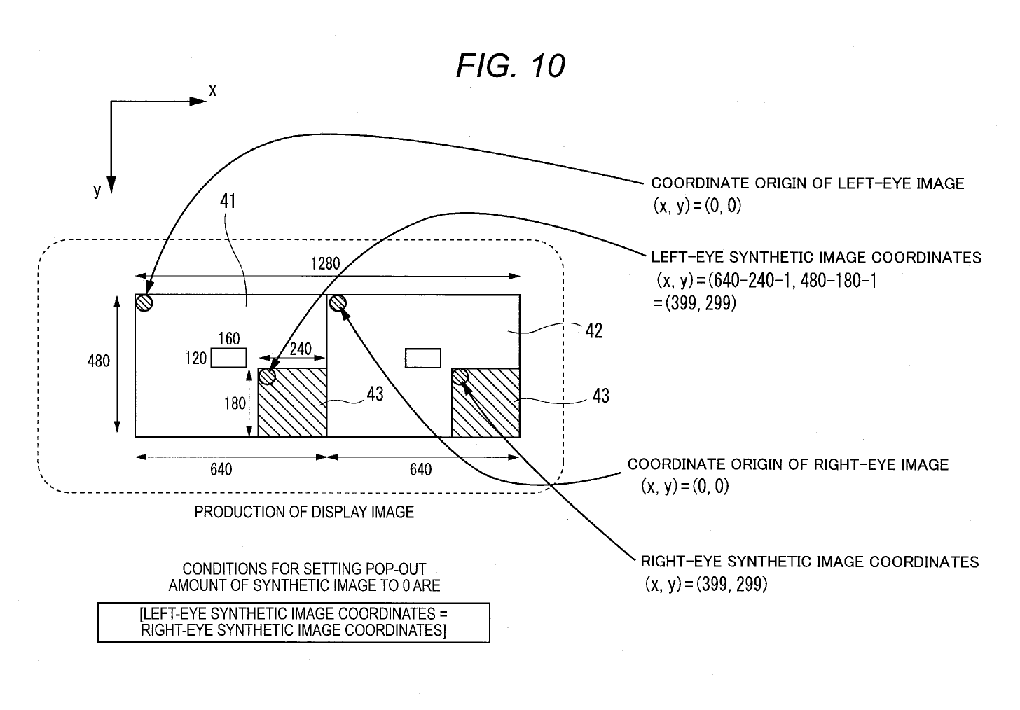

FIG. 10 is a view illustrating a method of controlling the depth position (controlling the pop-out amount/pop-in amount) of the AF area magnified image 43. With respect to the coordinate origin (0, 0) of the display image (left-eye image) 41, the left-eye synthetic image coordinates (x, y) of the upper left corner of the embedded image (AF area magnified image) 43 of the image are

x=640−240−1=399, and

y=480−180−1=299,

and (x,y)=(399,299).

When, with respect to the coordinate origin (0, 0) of the right-eye image (display image) 42, the right-eye synthetic image coordinates of the upper left corner of the embedded image 43 of the image are indicated by (x, y)=(399, 299) in the same manner as described above, that is,

left-eye synthetic image coordinates=right-eye synthetic image coordinates,

the pop-out amount of the synthetic image (AF area magnified image) 43 from the screen is zero. When [x value of left-eye synthetic image coordinates−x value of right-eye synthetic image coordinates]=α is adjusted, the pop-out amount and the pop-in amount, i.e., the parallax amount can be controlled. The control is performed by the synthetic image coordinate control section 33 in FIG. 2.

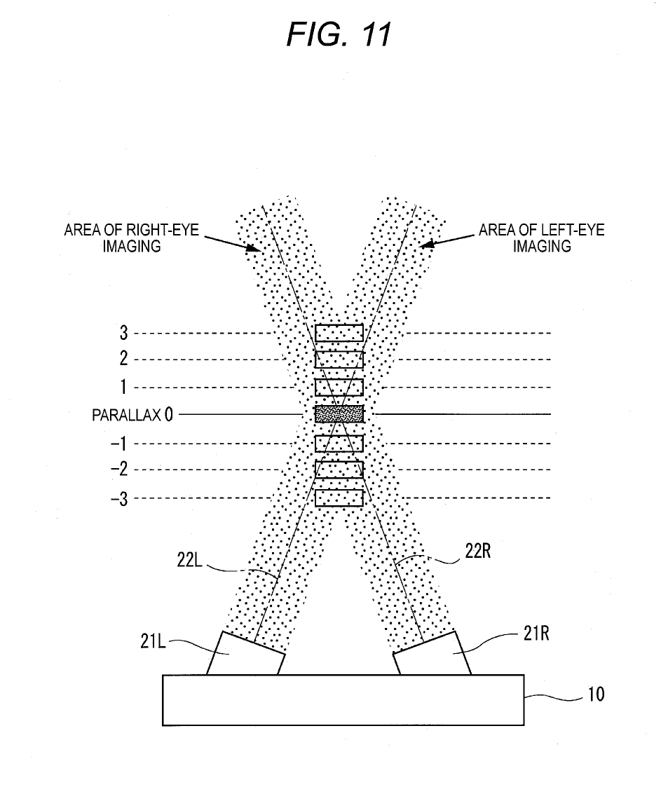

FIG. 11 is a view illustrating the misalignment amounts of the horizontal coordinates of the right and left images with respect to the parallax. In the embodiment, the optical axes 22L, 22R of the left and right imaging lens 21L, 21R of the stereoscopic camera 10 are fixedly disposed, and a three-dimensional image is produced by controlling the horizontal misalignment amounts of the right and left images by an image processing technique. In the embodiment, while using the principle, the pop-out and pop-in amounts of the AF area magnified image (planar image) are controlled.

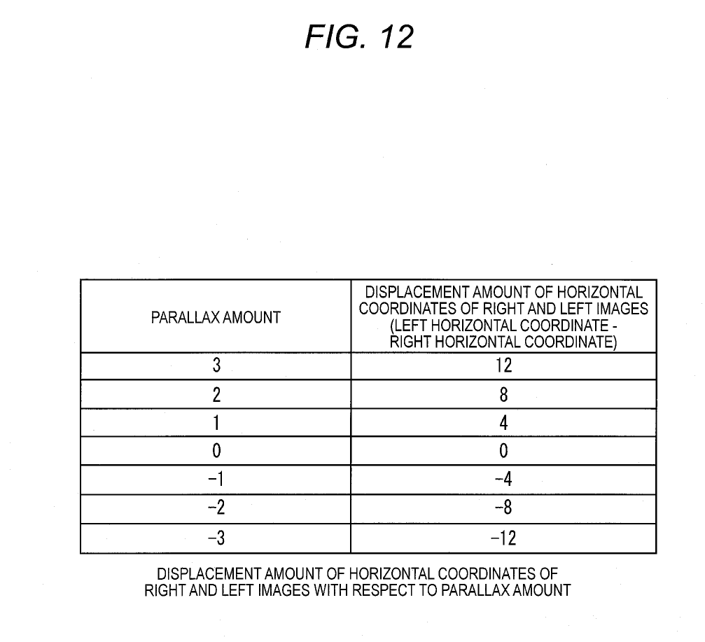

FIG. 12 is a view showing parallax amounts in the range of a of from −12 to +12 in the case where [x value of left-eye synthetic image coordinates−x value of right-eye synthetic image coordinates]=α. The more minus value of the parallax amount, the greater degree the image pops out toward the front side from the screen, and, the more plus value of the parallax amount, the greater degree the image pops in toward the back side from the screen.

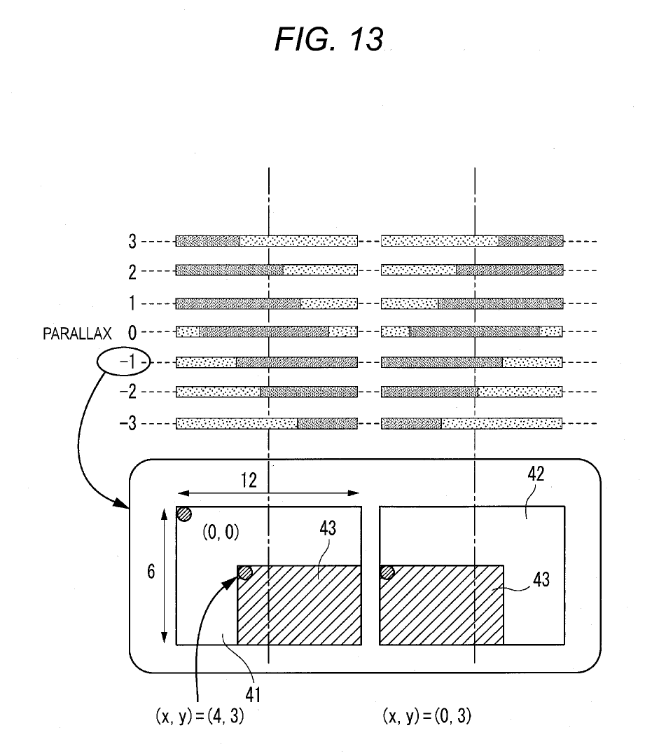

FIG. 13 is a view showing a control of the misalignment amount of the x coordinate of the AF area magnified image. The figure corresponds to a view obtained by extracting 12×6 pixels of upper left corner portions of the right and left embedded images 43 in FIG. 10.

With respect to the upper left corner coordinates (4, 3) of the image 43 embedded in the left-eye image 41, the upper left corner coordinates of the image 43 embedded in the right-eye image 42 are (0, 3), or horizontally displaced to the left side by four pixels, i.e., by −4 pixels. As seen from FIG. 12, namely, the AF area magnified image 43 is displayed while being popped out by a parallax amount of “−1” toward the front side.

When the AF area magnified image 43 is displayed while being popped out or popped in as described above, it is obvious at a glance that, in confirmation of focusing, attention is to be paid on which region of the object image that as a whole is displayed as a three-dimensional image. This is not limited to the case where the AF area magnified image 43 is displayed in the lower right display region 40 in the illustrated example. Even when the AF area magnified image 43 is displayed in any place of the screen, the same is applicable.

In a digital camera or the like, for example, a menu image, information related to imaging (information indicative of whether camera shake occurs or not, that indicative of whether the flashlight is allowed to emit light, and the like are often displayed in the form of icons), and the like are displayed on a display section as a 2D image. When the depth position (the pop-out amount or the pop-in amount) of the AF area magnified image 43 is displayed at the same depth position as information images other than a stereoscopic image, such as a menu image, a display image, for example, an icon related to imaging, or the like, therefore, the burden on the eyes of the user is reduced, and the visibility is improved.

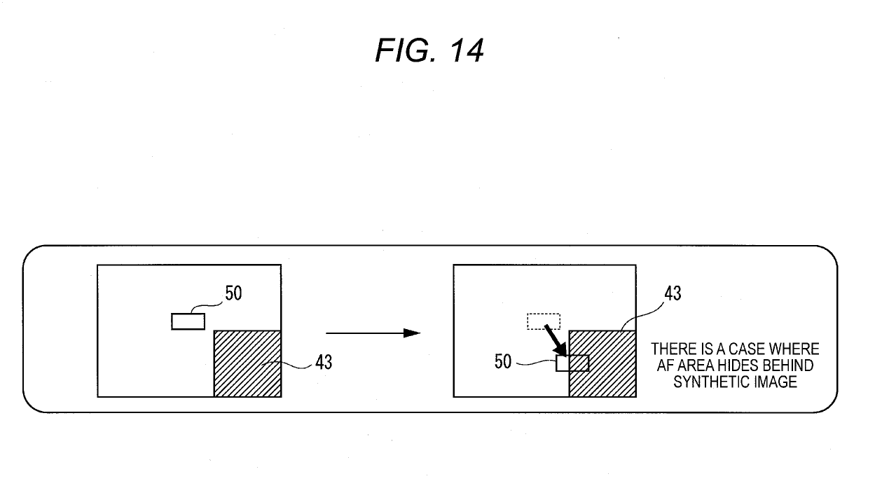

In the above-described embodiment, an AF detection area 50 is disposed at a predetermined position of the taken image, for example, the middle position of the screen as shown in the left figure of FIG. 14. However, there is an AF method in which focusing is always performed on a moving object by the function of the continuous AF (C-AF). In this case, the AF detection area 50 is moved in the screen as shown in the right figure of FIG. 14.

When the AF area magnified image (synthetic image) 43 is always fixedly displayed in the display region 40 in the fourth quadrant of a right lower portion of the screen, therefore, a situation occurs where the AF detection area 50 is moved to overlap the AF area magnified image 43.

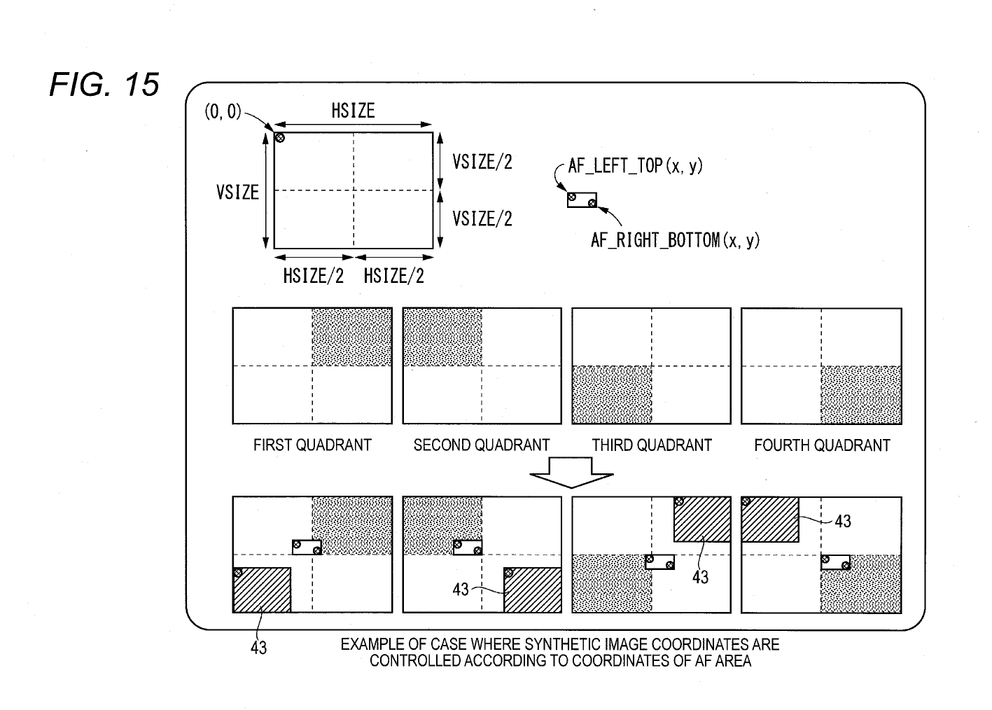

As shown in FIG. 15, therefore, the upper left corner coordinates of the AF detection area 50 are indicated as AF-LEFT-TOP(x, y), and the coordinates of the lower right corner are indicated as AF-RIGHT-BOTTOM(x, y). Preferably, the display position of the AF area magnified image 43 is controlled in accordance with the positions in the screen where these coordinates exist.

In the example shown in FIG. 15, in the case where AF-RIGHT-BOTTOM(x, y) is in the first quadrant of the screen, the AF area magnified image 43 is placed in a lower left region of the screen; in the case where AF-RIGHT-BOTTOM(x, y) is in the second quadrant of the screen, the AF area magnified image 43 is placed in a lower right region of the screen; in the case where AF-LEFT-TOP(x, y) is in the third quadrant of the screen, the AF area magnified image 43 is placed in an upper right region of the screen; and, in the case where AF-LEFT-TOP(x, y) is in the fourth quadrant of the screen, the AF area magnified image 43 is placed in a upper left region of the screen.

During the C-AF, as described with reference to FIG. 14, the AF detection area 50 is moved in following the object, and therefore there is a possibility that, when the AF detection area 50 overlaps the display region of the AF area magnified image 43, the area itself cannot be seen.

Therefore, the display region of the AF area magnified image 43 is disposed in a plurality of places, and the places are switched in accordance with the place where the AF detection area 50 exists. In the case where the AF detection area 50 functioning as the focus adjustment target region is moved in following the object, namely, the display control section 32 switches the display region 40 to a region where the area does not overlap the focus adjustment target region 50. According to the configuration, the AF confirmation image can be displayed in a place of the screen where the AF detection area 50 does not overlap the image.

Depending on the movement of the main object which is the shooting target, there is a possibility that the display region 40 of the AF area magnified image 43 is frequently switched over. In this case, the following configuration may be employed. The movement of the main object is predicted from the locus of the movement of the main object, and the display region 40 where there is no necessity of switching for a time period which is as long as possible is determined. The magnified image for AF confirmation is displayed in the determined display region 40. In a stereo camera having a touch panel display section 37, a configuration may be employed where the user can designate the display region for the AF confirmation image with one touch operation. According to the configuration, the visibility can be improved.

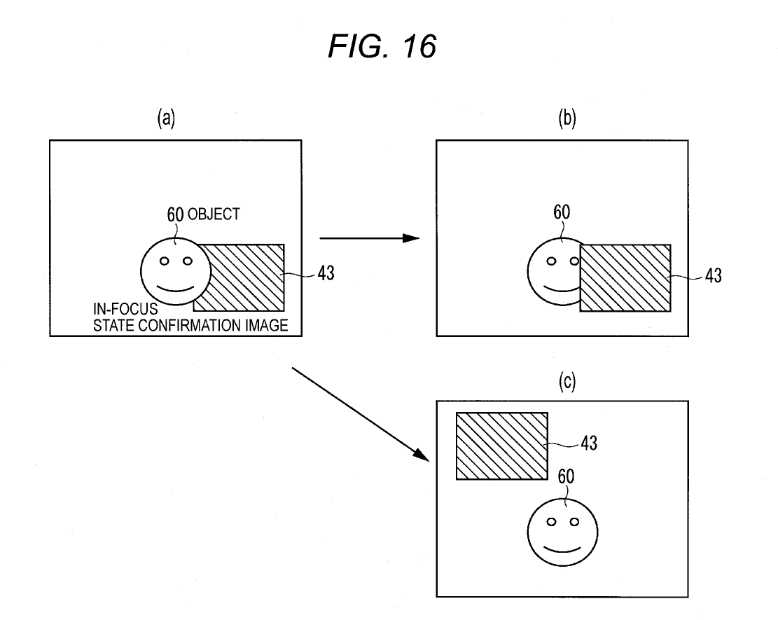

FIG. 16 is a view illustrating a method of displaying the in-focus state confirmation image in another embodiment of the invention. There is a case where, as shown in FIG. 16(a), a main-object image 60 (there is a case where the main object is focused, and there is another case where another main object is focused) of the object image overlaps the in-focus state confirmation image 43. This state can be known by using the function which is performed by the CPU 28 that is a main-object detection section, and in which the region where the main-object image exists is detected.

When this state occurs, a display control of the depth position of the in-focus state confirmation image 43 is performed, and the in-focus state confirmation image 43 is displayed on the front side of the main-object image 60 as shown in FIG. 16(b). As shown in FIG. 16(c), alternatively, the display region of the in-focus state confirmation image 43 is moved to a position where the image does not overlap the main-object image 60. Therefore, the focusing state can be easily confirmed.

In the above-described embodiment, the stereoscopic imaging apparatus having two lenses has been described. The above description can be applied as it is to a stereoscopic imaging apparatus having a single lens in which a first pixel group for taking an object image for the right eye, and a second pixel group for taking an object image for the left eye are disposed in a single imaging device.

As described above, the stereoscopic imaging apparatus of the embodiment is characterized in that the apparatus includes: a stereoscopic imaging section which takes an image of an object to obtain a plurality of images of different viewpoints; a display section which displays the plurality of images as a stereoscopic image of the object; and a display control section which overlappingly displays an image of a region on a part of the stereoscopic image as an in-focus state confirmation image, the region including a focus adjustment target region in taking of one of the plurality of images.

Moreover, the display control section of the stereoscopic imaging apparatus of the embodiment is characterized in that the section mutually displaces an overlapping position of the in-focus state confirmation image in a parallax direction to overlap each of the plurality of images, and controls a depth position of the in-focus state confirmation image.

Furthermore, the display control section of the stereoscopic imaging apparatus of the embodiment is characterized in that the section controls a depth position of the in-focus state confirmation image to be identical with a depth position of information other than the stereoscopic image displayed on the display section.

Furthermore, it is characterized in that the information other than the stereoscopic image in the stereoscopic imaging apparatus of the embodiment is a menu image or information of a display image related to imaging.

Furthermore, the display control section of the stereoscopic imaging apparatus of the embodiment is characterized in that the section magnifies and displays the in-focus state confirmation image in a display region other than the focus adjustment target region.

Furthermore, the stereoscopic imaging apparatus of the embodiment is characterized in that the apparatus includes a main-object region detection section which detects a region including at least a part of a main object in the stereoscopic image, and the region including at least the part of the main object is set as the focus adjustment target region.

Furthermore, the display control section of the stereoscopic imaging apparatus of the embodiment is characterized in that, in a case where the focus adjustment target region is moved in following the object, the display control section switches the display region to a region where the display region does not overlap the focus adjustment target region.

Furthermore, the stereoscopic imaging apparatus of the embodiment is characterized in that the apparatus includes a main-object region detection section which detects a region including at least a part of a main object in the stereoscopic image, and, when a display region for displaying the in-focus state confirmation image overlaps a main object, the display control section displays the in-focus state confirmation image at a depth position which is on a front side with respect to the image of the main object, or moves a display region of the in-focus state confirmation image to a position where the display region does not overlap the image of the main object.

Moreover, the method of displaying an in-focus state confirmation image in a stereoscopic imaging apparatus according to the embodiment is a method of displaying an in-focus state confirmation image in a stereoscopic imaging apparatus including: a stereoscopic imaging section which takes an image of an object to obtain a plurality of images of different viewpoints; and a display section which displays the plurality of images as a stereoscopic image of the object, and characterized in that an image of a region is displayed overlappingly on a part of the stereoscopic image, as an in-focus state confirmation image, the region including a focus adjustment target region in imaging of one of the plurality of images.

According to the above-described embodiment, the stereoscopic effect of the stereoscopic image of the object, and the in-focus state confirmation image (two-dimensional image) can be simultaneously confirmed on the same display screen, and, even in the case of a moving object, a high-quality stereoscopic image can be therefore taken without missing the photo opportunity.

### INDUSTRIAL APPLICABILITY

The stereoscopic imaging apparatus and method of displaying an in-focus state confirmation image therein according to the invention achieve the effect that the stereoscopic effect of a stereoscopic image of an object, and an in-focus state confirmation image (two-dimensional image) can be simultaneously confirmed, and, even in the case of a moving object, a high-quality image can be therefore taken without missing the photo opportunity, and is useful in a stereo camera configured by a digital camera.

Although the invention has been described in detail and with reference to the specific embodiments, it is obvious to a person skilled in the art that various changes and modifications can be made without departing from the spirit and scope of the invention.

The application is based on Japanese Patent Application (No. 2011-218531) filed Sep. 30, 2011, and its disclosure is incorporated herein by reference.

### REFERENCE SIGNS LIST

10 stereoscopic imaging apparatus (stereo camera)
15 shutter button
21R right-eye imaging lens
21L left-eye imaging lens
27 signal process section (DSP)
28 system control section (CPU)
31 resize section
33 synthetic image coordinate control section
37 liquid crystal display section
41, 42 display resized image
41a, 42a, 50 AF detection area
43 AF confirmation image (magnified image of AF area image)

1. A stereoscopic imaging apparatus comprising: a stereoscopic imaging section which takes an image of an object to obtain a plurality of images of different viewpoints; a display section which displays the plurality of images as a stereoscopic image of the object; and a display control section which overlappingly displays an image of a region on a part of the stereoscopic image as an in-focus state confirmation image, the region comprising a focus adjustment target region in taking of one of the plurality of images,
wherein the display control section causes the in-focus state confirmation image to overlap positions which are mutually displaced in respective parallax directions of the plurality of images, and controls a depth position of the in-focus state confirmation image.

2. The stereoscopic imaging apparatus according to claim 1, wherein the display control section controls a depth position of the in-focus state confirmation image to be identical with a depth position of information other than the stereoscopic image displayed on the display section.

3. The stereoscopic imaging apparatus according to claim 2, wherein the information other than the stereoscopic image is a menu image or information of a display image related to imaging.

4. The stereoscopic imaging apparatus according to claim 1, wherein the display control section magnifies and displays the in-focus state confirmation image in a display region other than the focus adjustment target region.

5. The stereoscopic imaging apparatus according to claim 1, wherein the apparatus includes a main-object region detection section which detects a region including at least a part of a main object in the stereoscopic image, and the region including at least the part of the main object is set as the focus adjustment target region.

6. The stereoscopic imaging apparatus according to claim 4, wherein, in a case where the focus adjustment target region is moved in following the object, the display control section switches the display region to a region where the display region does not overlap the focus adjustment target region.

7. The stereoscopic imaging apparatus according to claim 1, wherein the apparatus includes a main-object region detection section which detects a region including at least a part of a main object in the stereoscopic image, and, when a display region for displaying the in-focus state confirmation image overlaps a main object, the display control section displays the in-focus state confirmation image at a depth position which is on a front side with respect to the image of the main object, or moves a display region of the in-focus state confirmation image to a position where the display region does not overlap the image of the main object.

8. A method of displaying an in-focus state confirmation image in a stereoscopic imaging apparatus comprising: a stereoscopic imaging section which takes an image of an object to obtain a plurality of images of different viewpoints; and a display section which displays the plurality of images as a stereoscopic image of the object, wherein,
when an image of a region is displayed overlappingly on a part of the stereoscopic image, as an in-focus state confirmation image, the region comprising a focus adjustment target region in taking of one of the plurality of images,
the in-focus state confirmation image is caused to overlap positions which are mutually displaced in respective parallax directions of the plurality of images, and a depth position of the in-focus state confirmation image is controlled.
